(19) United States
(12) Patent Application Publication
(10) Pub. No.: US 2020/0088303 A1
(43) Pub. Date: Mar. 19, 2020

(54) Unibody Bypass Plunger With Integral Dart Valve Cage

(71) Applicant: Flowco Production Solutions, Spring, TX (US)

(72) Inventors: Garrett S. Boyd, Godley, TX (US); Mitchell A. Boyd, Haslet, TX (US)

(73) Assignee: Flowco Production Solutions, Spring, TX (US)

(21) Appl. No.: 16/130,635

(22) Filed: Sep. 13, 2018

(51) Int. Cl. F16K 1/00

(52) U.S. Cl. CPC F16K 1/00

(57) ABSTRACT

A bypass plunger formed as an integral one-piece hollow body-and-valve cage unit retains a dart valve within a valve cage section of the hollow body with a threaded retaining nut that may be secured by crimple means. A boundary zone, defined along the plunger body, where the integral valve cage section adjoins the plunger body, is configured with a uniform outer diameter to maximize the plunger body wall thickness and durability of the one-piece bypass plunger. The valve cage may have flow ports configured with ramps at an angle with the longitudinal axis to control flow through the flow ports during descent of the bypass plunger. A clutch assembly using garter springs with split bobbins may be disposed within the valve cage portion of the one-piece bypass plunger.

### CROSS REFERENCE TO RELATED APPLICATIONS

The present Application is related to U.S. patent application Ser. No. 14/796,548 filed Jul. 10, 2015 by the same inventors and entitled BYPASS PLUNGER, now U.S. Pat. No. 9,951,591 issued Apr. 24, 2018 incorporated herein by reference; and also related to U.S. patent application Ser. No. 15/048,467 filed Feb. 19, 2016 by the same inventors and entitled CLUTCH ASSEMBLY FOR BYPASS PLUNGERS, now U.S. Pat. No. 9,963,957 issued May 8, 2018 incorporated herein by reference; and also related to U.S. patent application Ser. No. 15/048,491 filed Feb. 19, 2016 by the same inventors and entitled and IMPROVED DART VALVES FOR BYPASS PLUNGERS, incorporated herein by reference. Any provisional application cited in the above related non-provisional applications is not relied on by the present application for priority.

### BACKGROUND OF THE INVENTION

### 1. Field of the Invention

The present invention generally relates to gas lift devices for rejuvenating low-producing or non-productive oil or gas wells, and more particularly to improvements in the design and construction of bypass plungers.

### 2. Background of the Invention and Description of the Prior Art

A conventional bypass plunger is a device that is configured to freely descend and ascend within a well tubing, typically to restore production to a well having insufficient pressure to lift the fluids to the surface. It may include a self-contained valve—also called a “dart” or a “dart valve” in some embodiments—to control the descent and ascent. Typically the valve is opened to permit fluids in the well to flow through the valve and passages in the plunger body as the plunger descends through the w ell. Upon reaching the bottom of the well, the valve is closed, converting the plunger into a piston by blocking the passages that allow fluids to flow through the plunger. With the plunger converted to a piston, blocking the upward flow of fluids or gas, the residual pressures in the well increase enough to lift the plunger and the volume of fluid above it toward the surface. Upon reaching the surface, the fluid is passed through a conduit for recovery, the valve in the plunger is opened by a striker mechanism, and the plunger descends to repeat the cycle.

In a typical bypass plunger the dart valve is similar to a poppet valve, with a valve head attached to one end of a valve stem, similar to an intake valve of an internal combustion engine. The valve head, at the inward end of the stem, may have a valve face surface configured to contact a valve seat within the hollow body of the plunger. The stem extends away from the valve head and protrudes outward of the bottom end of the plunger body. A clutch device may surround the stem of the valve to retard and control the motion of the stem and thereby maintain the valve in an open or closed configuration during respectively the descent or ascent of the plunger. The valve thus moves between these two positions to open the flow passages at the surface when the plunger contacts the striker mechanism, and to close the bypass passages at the bottom of the well when the stem strikes the bottom, usually at a bumper device positioned at the bottom of the well. Descent of the plunger is controlled by gravity, which pulls it toward the bottom of the well when the valve is open.

This dart valve may be held open or closed by the clutch—typically a device that exerts circumferential friction around the valve stem. The dart valve may be enclosed or supported within a hollow cage attached to the plunger by a threaded retainer or end nut at the lower end of the plunger assembly. Thus, the dart valve may be permitted to reciprocate between an internal valve seat (valve closed) in a hollow space inside the cage and the inside surface of the lower end of the cage (valve open). A clutch, which may be used to control the motion of the dart valve may be formed of a bobbin split into two cylindrical halves and surrounded by one or two ordinary coil springs. The springs function as a sort of garter to clamp the stem of the valve or dart between the two halves of the bobbin, thereby resisting the sliding motion of the dart valve stem within the bobbin. Each ‘garter’ spring is wrapped around its groove and the ends crimped together, typically in a hand operation that is subject to some variability in the tension around the bobbin halves and possible failure of the crimped joint, which could affect the reliability of the clutch when in a downhole environment.

While generally effective in lifting accumulated fluids and gas of unproductive wells such conventional bypass plungers tend to be complex and suffer from reliability problems in an environment that subjects them to high impact farces, very caustic fluids, elevated temperatures and the like. Various ways have been attempted to simplify construction of bypass plungers, improve their reliability and performance, and to reduce the cost of manufacture. However, failures remain common, and a substantial need exists to eliminate the causes of these failures. What is needed is a bypass plunger design that solves the structural problems with existing designs and provides a more reliable and efficient performance in the downhole environment.

### SUMMARY OF THE INVENTION

In one embodiment, a bypass plunger is disclosed comprising a one piece tubular plunger body having a first end and a second end, formed by a valve cage section joined to a main body section within a defined boundary zone disposed a predetermined distance from the first end; wherein the valve cage section is an integral part of the one-piece tubular plunger body. In several aspects, an outside diameter D1, where the integral valve cage section joins the boundary zone of the tubular plunger body, is substantially the same as an outside diameter D2 where the tubular plunger body joins the boundary zone; and the boundary zone comprises a region disposed along the tubular plunger body and defined between first and second cross-sections thereof having the respective outside diameters D1 and D2.

In other aspects, the boundary zone is oriented along a longitudinal axis of the one-piece plunger body; a valve seat formed inside the integral valve cage is disposed substantially within the boundary zone; and the integral valve cage section encloses a clutch-controlled dart valve assembly retained between a partition and a retainer threaded into the first end; wherein at least one of the partition and the retainer is secured by a locking device.

In other aspects, the integral valve cage section comprises a plurality of flow ports formed through the cylindrical wall of the integral valve cage section wherein the flow ports are each disposed outwardly at an angle with the longitudinal axis of the valve cage section and are separated by substantially equal angles around the cylindrical wall of the integral valve cage section; and the outward-oriented flow ports through the cylindrical wall include a ramp relief sloping outward toward the first end.

In other aspects, the dart valve assembly comprises a dart valve having a round stem enlarged at a first end to form a valve head, the valve head configured with a sealing surface disposed on its face; and a clutch disposed within the valve cage and surrounding the round stem; wherein the clutch comprises a split bobbin clutch disposed on the round stem within the integral valve cage section. Further, the dart valve assembly may include a partition device disposed within the integral valve cage and over the round stem for retaining the split bobbin clutch in position, wherein the split bobbin clutch is disposed between the partition device and a retainer; and the split bobbin clutch is clamped around the round stem of the dart valve by one or more garter springs, wherein each garter spring is disposed in a groove formed in the outer circumference of the split bobbin or in the face of the split bobbin.

In another embodiment, a bypass plunger apparatus comprises a main body segment; and a valve cage segment coupled through a defined boundary zone to the main body segment of the bypass plunger, thereby forming a one-piece tubular unit; wherein the boundary zone, configured with a substantially constant outer diameter includes an internal valve seat conformably shaped to the profile of a dart valve head.

In other aspects, the boundary zone is defined between a first D1 and a second D2 outer diameter cross sections disposed respectively at a length L and L+R inches from the open end of the valve cage segment; the internal valve seat is centered approximately L+R/2 inches from the open end of the valve cage; and the first and second outer diameter cross sections, designated respectively D1 and D2, are substantially equal to each other and to the outer diameter D3 of the main body; wherein the length L defines the nominal length of the valve cage; and the dimension R, the width of the boundary zone, is greater than or equal to 0.100 inch.

In another aspect, the substantially equal outer diameter of the boundary zone and the main body provide a boundary zone wall thickness that resists fracture of the one piece tubular bypass plunger during severe impacts.

### BRIEF DESCRIPTION OF THE DRAWINGS

FIG. 1 illustrates a side exploded view of one embodiment of a unitary bypass plunger according to the present invention;

FIG. 2 illustrates one embodiment of a split bobbin clutch for use with the embodiment of FIG. 1;

FIG. 3 illustrates a dart valve and split bobbin clutch assembly installed in the valve cage section of the unitary bypass plunger embodiment of FIG. 1 including the boundary zone and flow ports oriented at an angle with the longitudinal axis of the unitary bypass plunger and valve cage;

FIG. 4 illustrates a first cross-section view of an embodiment of FIG. 3 without a dart valve to depict flow port detail;

FIG. 5 illustrates a second cross-section view of an embodiment of FIG. 3 without a dart valve to depict flow port detail, rotated 90 degrees from the view depicted in FIG. 4; and

FIG. 6 illustrates a perspective view of a die for forming the crimple feature shown in the embodiment of FIG. 3.

### DETAILED DESCRIPTION OF THE INVENTION

In an advance in the state of the art, the one-piece bypass plunger described herein with the aid of the accompanying drawings yields improvements in a number of areas. The result is a novel combination of essential features incorporated in a unibody bypass plunger (aka unibody gas lift plunger) as disclosed herein. A principle component of the unibody bypass plunger is the one-piece plunger body including the integral valve age formed at its lower end. In other key features, the valve cage section of the one-piece plunger body has the same outside diameter as the outside diameter of the adjoining main body portion of the bypass plunger. The valve cage section and the main body section are joined within a defined boundary zone segment that includes a constant outer diameter along its width. The constant diameter feature enables the boundary zone segment to include a thicker wall of the valve cage around the valve seat and provides a much more robust bypass plunger proximate the location of the valve seat.

The valve cage assembly may include a dart valve and a clutch mechanism enclosed within the valve cage. A retaining nut (or end nut) may retain the dart valve and clutch mechanism within the cage completes the dart valve and cage assembly. The novel features of the present invention provide reduction of manufacturing costs, and enhanced performance, durability, and reliability, advantages that result through substantially greater simplicity of design and construction. The features of this novel combination are described as follows.

The one piece (“unitary”) plunger body-and-valve cage is an integrated structure that is hollow throughout its length. The one-piece plunger body includes flow ports through the wall of the integral valve cage (disposed at the lower end of the one-piece plunger body) that are configured to control the flow of fluid through the plunger on descent. During descent, the plunger falls through the well and any fluids therein. The fluids flow though the flow ports in the valve cage and the hollow body of the plunger. The flow ports formed in the wall of the valve cage may be oriented at different angles, varied in number, include a ramp relief sloping outward toward the lower or first end, etc. to adjust the rate of descent. The unitary or one-piece design thus includes, when viewed in side profile, a constant outside diameter through the boundary zone region along the one-piece plunger where the valve cage section adjoins the main body of the plunger. This one-piece, unibody design minimizes the number of parts and the number of joints that must be formed and secured. One principle benefit of the one-piece unibody construction is fewer parts to assemble and secure together, and the elimination of failures in the mechanisms used to secure the parts together.

In another aspect, the dart valve assembly includes a dart valve having a round stem enlarged at a first end to form a valve head, the valve head configured with a sealing surface disposed on its face. A clutch may preferably be disposed within the valve cage and surrounding the round stem; wherein the clutch is configured as a split bobbin clutch clamped around the round stem within the integral valve cage section. Further, the dart valve assembly may include a partition device disposed within the integral valve cage and over the round stem for retaining the split bobbin clutch in position, such that the split bobbin clutch is disposed between the partition device and a retainer. The split bobbin clutch may be held clamped around the round stem of the dart valve by one or more garter springs, wherein each garter spring is disposed in a groove formed in the outer circumference of the split bobbin or in the face of the split bobbin.

In another aspect, a retaining nut (or retainer) for retaining a dart valve and clutch assembly may be mated to the lower end of the valve cage segment of the hollow plunger body with a threaded joint and secured with a crimp (“crimple”) formed in at least two equally spaced locations around the proximate portion of the valve cage segment of the hollow plunger body. The crimple functions as an inward-formed dent that effectively indents the wall of the valve cage section of the hollow plunger body into a corresponding relief machined into the external threads of the (smaller) outside diameter of the retaining nut. The retaining nut (alternately “end nut”), thus threadably secured to the lower end of the valve cage, functions to close the open end of the valve cage and retain the dart valve within the valve cage.

The crimple feature eliminates the need for separate parts such as pins, screws, ball detents, lock nuts or washers, etc, to lock a threaded joint from loosening. The advantage of the crimple technique and mechanism is to more reliably prevent the inadvertent disassembly of the components secured to the bypass plunger with screw threads, thereby ensuring a true unibody bypass plunger that remains a single unit throughout many cycles of use. The term crimple is a contraction of the terms crimp and dimple, to characterize the crimp as approximating a crimp at a defined point as compared with a circumferential crimp.

The outer surface of the hollow one-piece plunger body of the present invention may include a series of concentric rings or ridges machined into the outer surface of the hollow body along the overall length of the hollow body at each end. The rings or ridges thus provided may act as a seal to minimize the clearance between the plunger and the inside of the well tubing through which it descends and ascends. In the illustrated embodiment a series of concentric spiral (or helical) grooves (not unlike the “valleys” of machine screw threads) may be machined into a central portion of the outer surface of the hollow body between, in one example, two groups of concentric rings, one group at each end of the hollow body, is. The “central” portion may typically (but not exclusively) be approximately the central one-third of the length of the hollow body. The pitch and profile of these spiral grooves may be varied between a tight helix and an open helix to vary the rate of spin of the plunger as it descends and ascends. The purpose of spinning the plunger is to prevent flat spots from forming on the outside surface of the plunger, which reduce the effectiveness and the useful life of the bypass plunger. The cross section profile of the grooves may also be varied to facilitate the spin rate.

In the appended drawings, reference numbers that appear in more than one figure refer to the same structural feature. The drawings are not necessarily to scale—detail features shown in the drawings may be enlarged to more clearly depict the illustrated feature. The drawings depict at least one example of each embodiment or aspect to illustrate the features of the present invention and are not to be construed as limiting the invention thereto. It should be understood that the term “plunger dart” or simply “dart” may also refer to a dart valve herein, all of which refer to the same component.

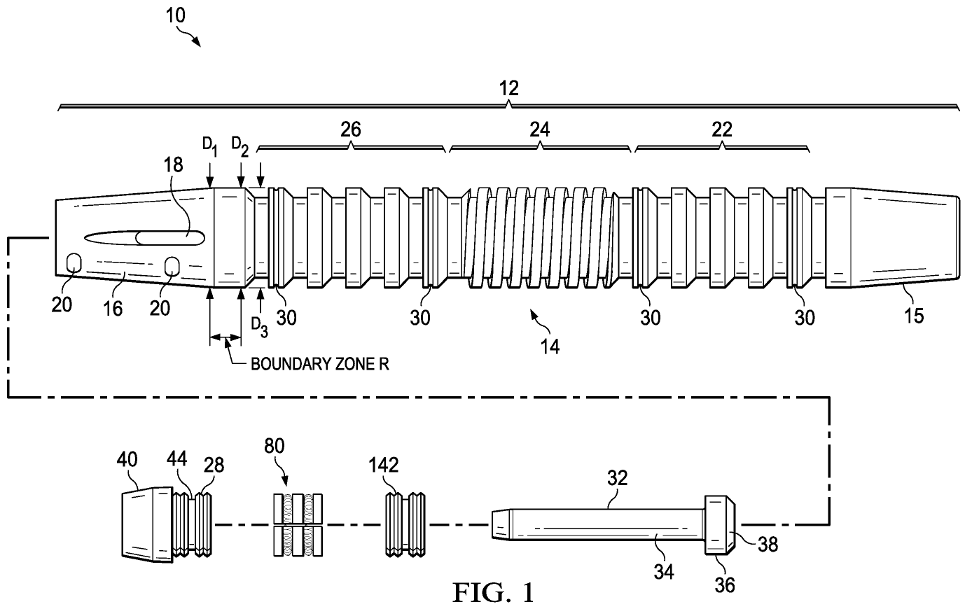

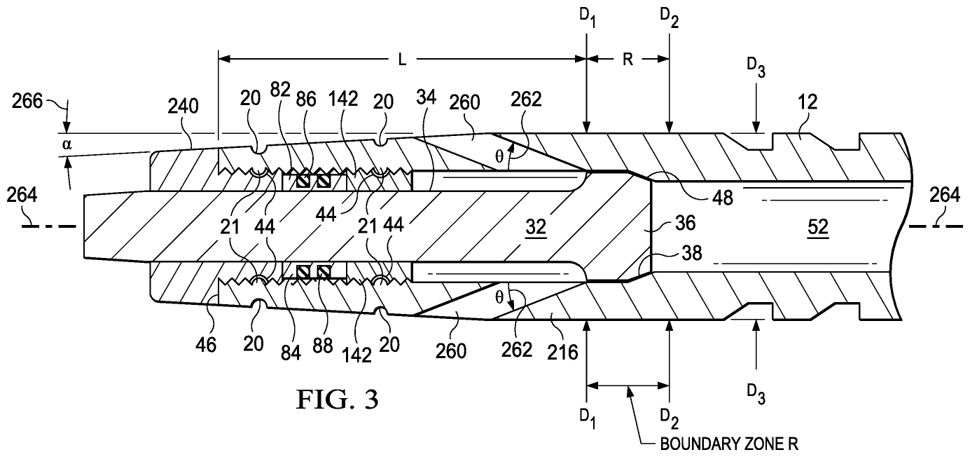

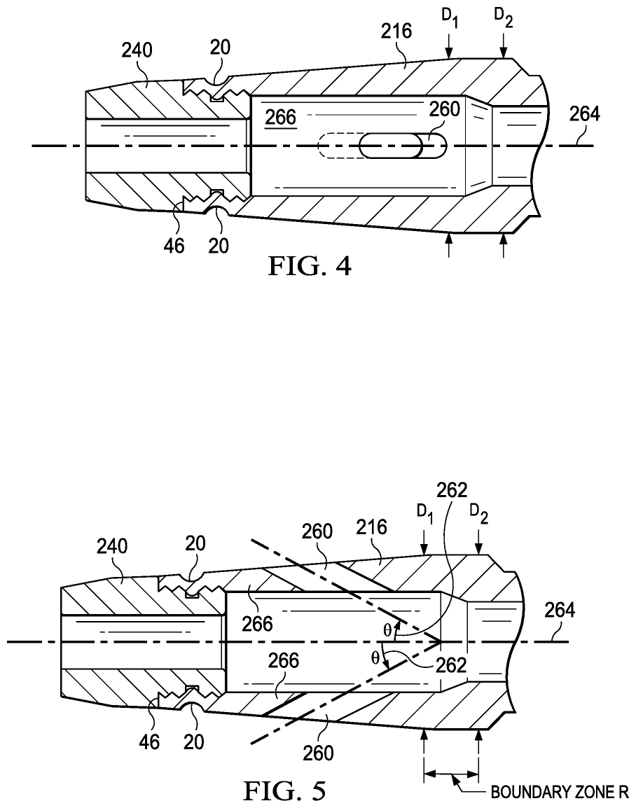

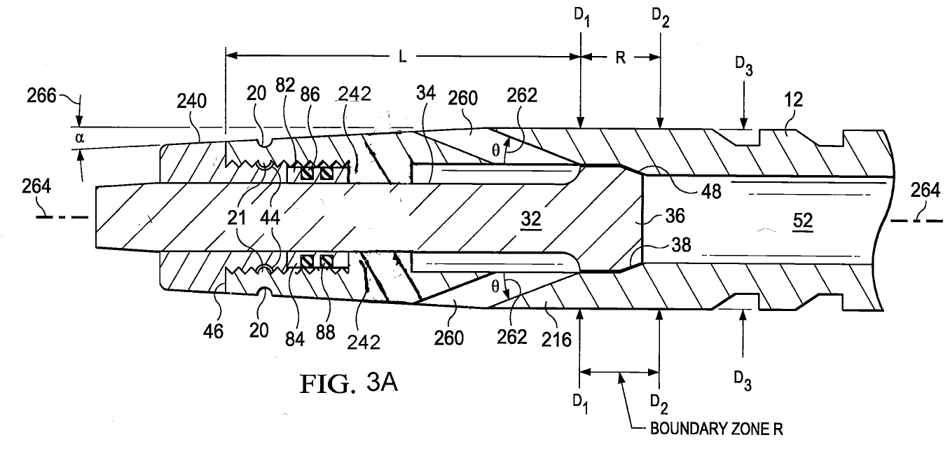

FIG. 1 illustrates a side exploded view of one embodiment of an integrated, one-piece, unibody bypass plunger 10 according to the present invention. The one-piece bypass plunger 10 is formed as a single hollow plunger body 12 machined from a suitable material such as a stainless steel alloy. Such materials are well known in the art. Forming the hollow plunger body 12 as a single piece simplifies construction by reducing the number of parts to be connected together with screw threads, thereby reducing the opportunities for failure when a threaded joint fails. The valve cage 16 section (or segment) of the one-piece plunger body 12 is shown having the same outside diameter D1 as the outside diameter D2 of the adjoining main body portion 14 of the plunger body 12, within a defined boundary zone “R” as described further in FIG. 3. Moreover, the profiles of the flow ports in the valve cage 16, and the sealing rings 22,26, and the centralized helix 24 of the main body portion 14 may all be readily tailored during manufacture for a specific application.

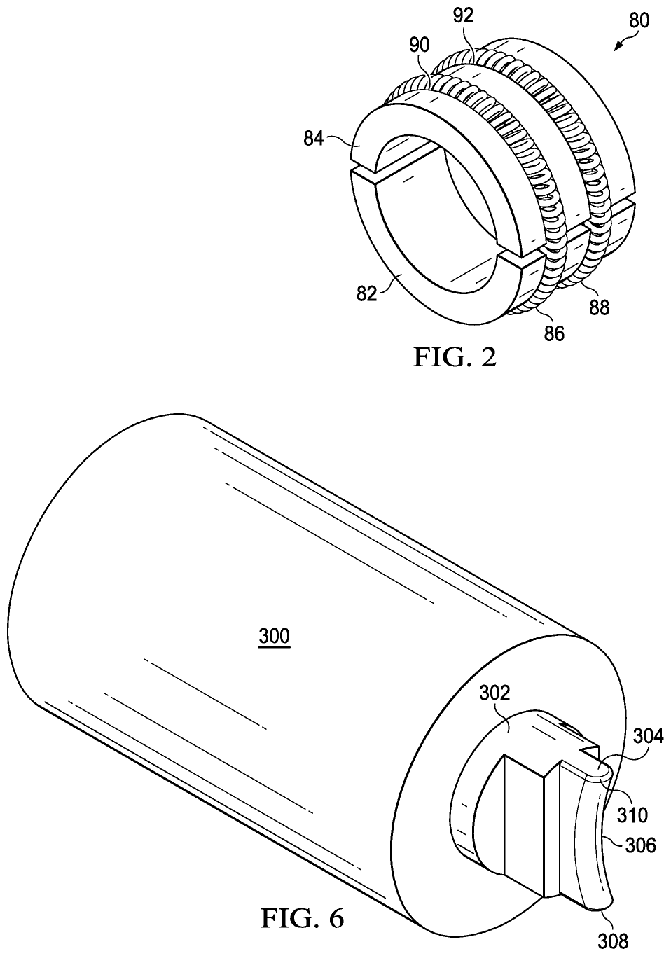

The plunger body 12 may include the following defined sections: an ID fishing neck 15, the main body portion 14 comprising an upper section of sealing rings 22, an intermediate or central section of helical ridges or grooves 24, and a lower section of sealing rings 26, and the valve cage segment 16 for enclosing and retaining a poppet valve or valve dart 32. The valve cage segment 16 may include a plurality of flow ports 18 disposed at typically two to four equally-spaced radial locations around the wall of the valve cage segment 16. In the illustrated embodiment, two or more crimples 20 to be described may be positioned as shown near the lower end of the valve cage segment 16. The crimple 20 provides a mechanism to lock a retaining nut or end nut 40 that may be threaded on or into the open, lower end of the valve cage segment 16. The one piece hollow plunger body 12 may further include wear grooves 30 disposed at selected ones of the sealing rings 22, 26 as shown. Further, disposed within the retaining or end nut 40 when the bypass plunger is assembled is a split bobbin clutch 80. This clutch design will be described below in FIG. 2.

Continuing with FIG. 1, the assembly of the illustrated bypass plunger 10 includes a dart valve 32 inserted head-end first through the valve cage 16 into the lower end of the hollow body 12. The valve head 36 and its sealing face 38 form a poppet valve head at the end of stem 34. When installed in the hollow body 12, the sealing face 38 of the poppet valve or dart valve 32 is shaped to contact a valve seat 48 machined into the internal bore 52 of the hollow body 12 as shown in FIG. 3 that depicts the valve dart 32 in a closed position. The valve dart 32 may be retained within the valve cage 16 by the retaining nut 40 (also end nut 40) that may be installed in the lower end of the valve cage 16 and secured by screw threads 28 (See enlarged view in FIG. 3). The retaining nut 40 includes in this embodiment an external circular groove 44 around a mid-part of its threaded portion. This groove 44 provides a relieved space so that a crimple 20 to be described may extend into the groove 44 to lock the external threads of the end nut 40 to corresponding internal threads in the lower end of the valve cage 16. The split bobbin clutch 80 may be retained within the valve cage 16 by a partition nut 142 threaded into the threaded internal bore of the valve cage 16, or by a partition machined into the internal bore of the valve cage in the same position as the partition nut 142 depicted in FIG. 3.

In FIG. 2, one typical component used with a dart or poppet valve in a bypass or gas-lift plunger is some form of clutch to restrain the motion of the dart, thereby ensuring the efficient operation of the dart in controlling the operation of the plunger. A split-bobbin clutch as shown in FIG. 2 may employ a circular bobbin split into two equal cylindrical or semi-circular halves 82, 84 to enable convenient assembly around the stem 34 of the dart or poppet valve 32. The two halves 82, 84 are generally held against the stem 34 by one or more (usually two) so-called “garter springs” 86, 88 disposed in grooves 90, 92 respectively surrounding the bobbin assembly 82, 84. Each bobbin half 82, 84 encircles the stem 34 for slightly less than a full 180 degrees, so that the inside surface of each bobbin half 82, 84 may make direct contact with the stem 34 of the dart valve 32 under the tension provided by the garter spring or springs 86, 88. The clutch assembly is generally secured within the valve cage portion of the body of the plunger through which the dart valve reciprocates during its use. The clutch assembly 80, through the friction exerted against the stem 34, acts to retard the motion of the stem 34 within the valve cage section 16 of the bypass plunger 10 and so that it remains in the required closed or opened position during ascent or descent respectively through the well tubing.

FIG. 3 illustrates an embodiment of the present invention that depicts a valve cage shown with a split bobbin clutch 80 and a dart valve 32 in a closed position. The clutch is shown with first 86 and second 88 garter springs encircling the split bobbin 82, 84. The split bobbins may be encircled by one or two garter springs in the manner of FIG. 5. A partition nut 142, for retaining the clutch assembly 80 between the retaining or end nut 40 and the partition nut 142, is shown adjacent to the clutch bobbin 82, 84. The partition nut 142 is provided to ensure the assembly of the split bobbin halves 82, 84 and the garter springs 146 remains in position between the end nut 40 and the partition or partition nut 142. In some implementations a partition or other bulkhead feature (not shown) may be machined into the internal bore (See FIG. 3) of the valve cage 216 in the position of the partition 142.

The body 12 of the one-piece plunger is depicted in FIG. 3 with a dart valve 32 in a closed position such that the valve face 38 of the dart valve head 36 is in contact with a conforming valve seat 48 formed in the tubular bore 52 of the main body section 12. The dart valve 32 is retained within the valve cage section by a retaining nut 240 that is screwed into mating threads in the open end of the valve cage 216. The threaded joint may be locked using a crimple device 20 to be described. The dart valve 32 may in some implementations have a particular surface finish (not shown) to provide a controlled amount of friction so that operation of the dart valve is more predictable. This “closed valve” condition is the configuration of the bypass plunger as it ascends upward toward the surface to lift a payload of fluid toward the surface to enhance production of a well.

Continuing with FIG. 3, the crimple 20 may be used to deform the wall of the end nut 40 and the valve cage 16, so that an extended portion of the crimple 20 protrudes into a respective relieved portion 44 of the screw threads of both the retaining nut 40 and the partition nut 142. Persons skilled in the art will appreciate that the relieved portion 44 may be machined as a grooved segment, a drilled hole of limited depth, or a punched opening that may be round, oval, or rectangular in shape. The formation of the crimple 20 on the outer surface of the valve cage 16 may extend into the threads of the retaining nut 40 sufficiently to prevent the retaining nut from loosening.

Alternatively, the profile of the crimple (or detent) 20 may be approximately conical in form, as though formed by a center punch having a conical point. In practice, the crimple detent 20 may be formed using a press as is well-known in the art. The detent 20 is preferably placed in at least two locations, on opposite sides of the valve cage 16—i.e., approximately 180 degrees apart around the body of the valve cage 16 as shown in FIG. 3. The crimple 20 thus functions similar to a set screw or a pin to prevent the loosening of the screw threads of the retaining nut 40 and the partition nut 142. Use of the crimple feature has been found to be as effective as pins or screws but less expensive to manufacture and assemble. Other methods such as keys or lock nuts may be used but are not as easily implemented.

The cross-section view of the embodiment of FIG. 3 includes flow ports 260 that may be oriented at an angle θ 262 with the longitudinal axis 264 of the unitary bypass plunger 10 including a portion of the plunger body section 12 and the valve cage section 216. In this view two flow ports 260 disposed at the angle θ 262, preferably 90 degrees (See FIG. 5) relative to the longitudinal axis 264 are shown. Also shown is the approximate disposition of the outside diameter D1 of the valve cage section 216 and the outside diameter D2 of the plunger body section 12 at the cross-sectional edges of a defined boundary zone “R” along the one-piece bypass plunger 10 where the valve cage section 216 adjoins the main body section 12.

The boundary zone R is an important feature of the integrated, one-piece bypass plunger 12 described herein. It straddles the position along the longitudinal axis of the bypass plunger where the valve cage section 16 (216 in FIG. 3) meets the main body section (or segment) 14 of the one-piece bypass plunger 12. Thus, the one-piece bypass plunger 10 has three integrated sections or segments: a valve cage section 16 joined with a main body section 14 within a boundary zone R. Hie boundary zone R also defines the portion of the one-piece bypass plunger 10 that includes a constant outer diameter (D1, D2 and D3) so that the strength of the valve cage wall is maximized. The boundary zone R is also where the valve seat 48 is placed, to position it in the strongest part of the one-piece bypass plunger 12 where the impact can be most severe. The boundary zone R is thus an element of the integrated one-piece bypass plunger apparatus 10 that has the specific attributes described herein. These attributes form part of the novel combination of the apparatus. The designation “R” denotes both the boundary zone element itself and the dimension of its width along the longitudinal axis of the integrated, one-piece bypass plunger 12.

The boundary zone R may be defined as the axial length of the one-piece bypass plunger 12 between the outside diameters D1 and D2. A. minimum practical value for R may be 0.100 inch; a nominal practical value for Z may range between 0.190 inch and 0.300 inch. In some embodiments the value of R may exceed this range. In one implementation but without limitation the diameters D1 and D2 may straddle the approximate location of the dart valve seat 48 formed within the one-piece plunger body 12. The outside diameter D3 represents the nominal outside diameter of the main body 14 of the one-piece bypass plunger 12.

The boundary zone R is preferably defined between a first D1 and a second D2 outer diameter cross sections that are disposed respectively at a length L and L+R inches from the open end of the valve cage section or segment 216. In this aspect, the internal valve seat 48 is centered approximately L+R/2 inches from the open end of the valve cage section 216, and the first and second outer diameter cross sections, designated respectively D1 and D2, are substantially equal to each other and to the outer diameter D3 of the main body section 14. The length L defines the nominal length of the valve cage section 216; and the dimension R, the width of the boundary zone, is generally greater than or equal to 0.100 inch.

The dimensions D1 and D2 define an important property of the present invention: a subtle but critical improvement in the construction of bypass plungers to ensure a robust, longer-lasting service life because of the thicker walls of the one-piece tubular bypass plunger-and-valve cage unit. The thicker wall in the vicinity of the dart valve seat disposed approximately within the defined boundary zone R is provided in the otherwise weakest part of the unitary structure. The defined boundary zone R is also a region where the repetitive and severe impact is most often imparted to the plunger body, the dart valve seat and the dart valve when the bypass plunger contacts the bottom of the well bore following a long free fall downward through the well. The one-piece construction also eliminates the need for fasteners or threads to secure the plunger body and valve cage sections together.

As further shown in FIG. 3, the separation between the dimensions D1 and D2 is indicated by the width of the defined boundary zone R. The defined boundary zone R may, for example, extend to approximately coincide with the location of the dart valve seat 48. A preferred minimum width of the defined boundary zone R to ensure an adequately robust one-piece plunger body/valve cage unit with an adequate safety margin is 0.190 inch. The value of the width R of the boundary zone may be increased in some implementations to 0.300 inch or more depending on the dimensions of the unitary bypass plunger 10.

To achieve the thicker wall of the valve cage section 16 its outer diameter D1 near the boundary zone R is increased to the outer diameters D2 and D3 while maintaining the same small taper angle α 268, which in the illustrated example is shown as nominally 2.5 degrees. Thus the outer diameter of the valve cage 16 along its full length can be increased to maintain the same angle α 268, to provide a stronger, more robust valve cage 16 and plunger body 12 unit. While the taper angle α may vary in plungers designed for certain applications, the 2.5 degree value is a practical, illustrative example.

Persons skilled in the art will appreciate that the relieved portion 44 may be machined as a grooved segment, a drilled hole of limited depth, or a punched opening that may be round, oval, or rectangular in shape. The formation of the crimple 20 on the outer surface of the valve cage 16 may extend into the threads of the retaining nut 40 sufficiently to prevent the retaining nut from loosening. Alternatively, the profile of the crimple (or detent) 20 may be approximately conical in form, as though formed by a center punch having a conical point. In practice, the crimple detent 20 may be formed using a press as is well-known in the art. Tire detent 20 is preferably placed in at least two locations, on opposite sides of the valve cage 16—i.e., approximately 180 degrees apart around the body of the valve cage 16 as shown in FIG. 3.

FIGS. 4 and 5 each illustrate a cross-section view of an embodiment of the valve cage 216 of FIG. 3 without a dart valve to depict flow port detail. In FIG. 4 a flow port 260 is shown as viewed from inside the valve cage 216, oriented through the side wall 266 of the valve cage section 216. In FIG. 5 two flow ports 260 are shown as passages through the side wall 266 and oriented at an angle θ 262, preferably 90 degrees relative to the longitudinal axis 264 as indicated by the angle θ 262 formed by the intersection of the centerline 270 of the flow ports 260 with the centerline 264 of the integrated one-piece plunger body-and-valve cage unit 12. A ramp relief 272 formed in the end of the flow ports 260 that slope toward the lower (first) end permit fluids to flow through the integrated one-piece bypass plunger 10 more freely as it descends in the well bore after the dart valve (not shown in these views) is opened at the surface.

FIG. 6 illustrates one example of a die for use in a press to form a crimple used in the embodiments of FIGS. 1 and 3, 4 and 5. The body 300 of the die includes a reduced diameter shank 302 that is shaped at its end to form the crimple 20 in the outer surface of the valve cage 16 portion of the one-piece (“unibody”) bypass plunger body 12 as shown in FIG. 1. The crimple 20 is shown in detail in FIG. 3. The crimple 20, an indentation into the outer surface of the valve cage 216, is produced by the shape of the crimple blade 304. The crimple blade 304 as shaped includes a major radius 306, a minor radius 308, and a fillet radius 310. The major radius 306 shapes the blade 304 to the radius of the plunger body 12 at the location of the crimple 20. The major radius is formed to a radial dimension slightly larger than the body of the plunger to be formed. Thus, when the blade 304 contacts the plunger body and begins to form the crimple 20, the stresses produced in the metal body of the plunger tend to flow outward, forming a smoother crimple 20. Different plunger body diameters will, of course require separate dies having the appropriate major radius for the work piece.

The minor radius 308 may be provided for a similar reason—to allow the stresses of formation to flow outward along the work piece. A small fillet radius 310 may be provided on the outside edges of the blade 304 to reduce stress riser occurrence, a phenomenon well-understood in the machine arts. The operation of the press with the die 300 installed preferably proceeds in a slow, controlled manner, after the work piece—the body 12 of the plunger—is supported in a fixture or vise (the vise is not shown, as it is not part of the invention as will be recognized by persons skilled in the art) opposite the die 300. This procedure achieves the desired crimp 21 into the recess 44 of the retaining nut 40 as shown in FIG. 3. The curvatures of the major 306, minor 308, and fillet 310 radii, besides reducing stresses in the metal also retard the formation of cracks, both during manufacturing and during use of the bypass plungers in the field, where the plunger is subject to hard impacts under some conditions.

While the invention has been shown in only one of its forms, it is not thus limited but is susceptible to various changes and modifications without departing from the spirit thereof. For example, the profiles of the flow ports in the cage, the form of the dart valve—its round stem, valve head, and the corresponding valve seat within the boundary zone of the plunger body, the number of coil springs used within the split bobbin clutch assembly, the shape of the crimple and the die used to form it, are some illustrative examples of variations that fall within the scope of the invention. Moreover, the crimple feature is a technique that may be used in place of set screws, pins, keys, lock nuts, etc., to secure threaded components from turning relative to each other. For example, end nuts or retainers or retaining nut at either end of a plunger body or a bumper spring or other similarly constructed device, may employ a crimple as described herein to useful advantage. The split bobbin clutch may also be used in other structures for controlling sliding or reciprocating motion of a shaft within the bore of a corresponding structure of a device.

1. A bypass plunger, comprising:
a monolithic one-piece tubular plunger body having a first end, a second end, a valve cage section, a boundary zone, and a main body, wherein:
the valve cage section is between the first end and the boundary zone and includes a flow port,
the boundary zone is between the valve cage portion and the main body,
the main body is between the boundary zone and the second end,
the valve cage section is tapered, according to a fixed taper angle, having a diameter that varies linearly from a first diameter at the boundary zone to a second diameter at the first end, and
the boundary zone includes an internal valve seat conformably shaped to a profile of a dart valve head, the valve seat having a first portion that is angled relative to a longitudinal axis of the bypass plunger, and a second portion extending between the first portion and an edge of the flow port.

2. The bypass plunger of claim 1, wherein the boundary zone has a uniform exterior diameter.

3. The bypass plunger of claim 1, wherein the boundary zone comprises:
a region disposed along the monolithic one-piece tubular plunger body and defined between first and second cross-sections thereof having respective first and second diameters.

4. (canceled)

5. The bypass plunger of claim 1, wherein:
the valve cage section encloses a clutch-controlled dart valve assembly retained between a partition nut and a retainer threaded into the first end; and
at least one of the partition nut and the retainer is secured by a locking device.

6. (canceled)

7. The bypass plunger of claim 1, wherein the valve cage section comprises:
an internal bore defining a cylindrical wall thereof, the internal bore extending from the boundary zone to the first end, the internal bore configured to receive a dart valve assembly therein; and
a plurality of flow ports formed as passages through the cylindrical wall of the valve cage section, wherein the passages form an angle with respect to the longitudinal axis.

8. The bypass plunger of claim 7, further comprising a dart valve assembly comprising:
a dart valve having a round stem enlarged at a first end to form a valve head, the valve head configured with a sealing surface.

9. The bypass plunger of claim 7, wherein:
the dart valve is configured to move reciprocatingly within the internal bore between a closed position in contact with a valve seat, formed in the monolithic one-piece tubular plunger body within the boundary zone, and an open position disposed away from the valve seat.

10. The bypass plunger of claim 7, wherein:
the flow ports are each oriented outwardly from the longitudinal axis of the valve cage section and are separated by equal angles around the cylindrical wall of the valve cage section.

11. The bypass plunger of claim 10, wherein:
the outward-oriented flow ports through the cylindrical wall include a ramp relief sloping outward toward the first end.

12. The bypass plunger of claim 1, wherein the valve cage section further comprises:
a first thread at the first end configured to receive a retainer that retains a dart valve within the valve cage section;
a retainer having a second thread to allow the retainer to be threaded on the valve cage section; and
a locking device configured to secure the retainer to the valve cage.

13. The bypass plunger of claim 12, wherein:
the first thread is an internal thread and the second thread is an external thread.

14. (canceled)

15. The bypass plunger of claim 1, wherein the valve cage section comprises:
a clutch disposed within the valve cage section;
a partition nut disposed in a mid-portion of the internal bore of the valve cage section to limit a position of the clutch.

16.-17. (canceled)

18. The bypass plunger of claim 12, wherein the locking device comprises:
a locking mechanism selected from the group consisting of a crimple, a pin, a key, and a set screw.

19. The bypass plunger of claim 18, wherein the crimple comprises:
a displacement, formed by a die, of the wall of the valve cage into a recess machined in an outer circumference of the portion of the retainer proximate the inner surface of the valve cage.

20. The bypass plunger of claim 8, comprising:
a clutch enclosed within the valve cage section and disposed surrounding the round stem of the dart valve, the clutch configured to control movement of the dart valve.

21. The bypass plunger of claim 20, wherein the clutch comprises:
a split bobbin clutch disposed on the round stem within the valve cage section.

22. The bypass plunger of claim 21, further comprising:
a partition device disposed within the valve cage and over the round stem, the partition device configured to retain the split bobbin clutch in a fixed position,
wherein the split bobbin clutch is disposed between the partition device and a retainer.

23. The bypass plunger of claim 21, wherein the split bobbin clutch is clamped around the round stem of the dart valve by one or more garter springs.

24. The bypass plunger of claim 23, wherein each garter spring is disposed in a groove formed in an outer circumference of the split bobbin or in a face of the split bobbin.

25. A bypass plunger apparatus, comprising:
a main body segment;
a valve cage segment, having a flow port; and
a boundary zone separating the main body from the valve cage segment,
wherein the main body, the valve cage segment, and the boundary zone form a monolithic, one-piece tubular unit, wherein:
the boundary zone has a constant outer diameter and includes an internal valve seat conformably shaped to a profile of a dart valve head, the valve seat having a first portion that is angled relative to a longitudinal axis of the bypass plunger, and a second portion extending between the first portion and an edge of the flow port; and
an outside diameter of the valve cage segment is tapered with a uniform taper angle from a first end of the monolithic one-piece tubular plunger unit to the boundary zone.

26. The apparatus of claim 25, wherein:
the boundary zone has a length R along a longitudinal axis of the bypass plunger and is defined between a first outer diameter cross section D1 and a second outer diameter cross section D2 disposed respectively at a length L and a length L+R from an open end of the valve cage segment.

27. The apparatus of claim 26, wherein:
the internal valve seat is centered at a length L+R/2 from the open end of the valve cage segment.

28. The apparatus of claim 26, wherein:
an outer diameter of the first outer diameter cross section D1 and an outer diameter of the second outer diameter cross section D2 are equal to one another and are equal to an outer diameter D3 of the main body.

29. The apparatus of claim 28, wherein:
the equal outer diameters of the first outer diameter cross section D1, the second outer diameter cross section D2, and the outer diameter D3 of the main body provide a boundary zone wall thickness that resists fracture of the monolithic one-piece tubular bypass plunger during impacts.

30. The apparatus of claim 26, wherein:
the length L is a nominal length of the valve cage; and
the length R is greater than or equal to 0.100 inch.
